(19) United States
(12) Patent Application Publication
(10) Pub. No.: US 2025/0084905 A1
(43) Pub. Date: Mar. 13, 2025

(54) BRAKE DEVICE FOR VEHICLE

(71) Applicant: DENSO CORPORATION, Kariya-city (JP)

(72) Inventors: TOMOHIKO TSURUTA, Nisshin-city (JP); YUKI FUJII, Kariya-city (JP)

(21) Appl. No.: 18/962,518

(22) Filed: Nov. 27, 2024

Related U.S. Application Data
(63) Continuation of application No. PCT/JP2023/018417, filed on May 17, 2023.

(30) Foreign Application Priority Data
May 31, 2022 (JP) 2022-089069

(51) Int. Cl. F16D 65/847; B60T 13/74; F16D 55/226; F16D 65/18; F16D 65/78; F16D 121/24; F16D 125/34; F16D 125/48; H02K 5/04; H02K 7/06; H02K 7/116; H02K 11/33

(52) U.S. Cl. CPC F16D 65/847; B60T 13/746; F16D 55/226; F16D 65/18; H02K 5/04; H02K 7/06; H02K 7/116; H02K 11/33; F16D 2065/785; F16D 2121/24; F16D 2125/34; F16D 2125/48

(57) ABSTRACT

A linear motion converter is held by a caliper that holds a pad, and is capable of converting a rotation from the speed reducer into a linear motion and pressing the pad against a disk. An electronic circuit controls a rotation of an electric motor. A caliper-side speed reducer housing is provided to accommodate a portion of the speed reducer and to be connected to the caliper. A motor-side speed reducer housing is provided to accommodate a portion of the speed reducer and to be connected to the caliper-side speed reducer housing. The electric motor is provided on the caliper-side speed reducer housing side with respect to the motor-side speed reducer housing. The electronic circuit is provided on the opposite side of the motor-side speed reducer housing to the caliper-side speed reducer housing. A thermal conductivity of the caliper-side speed reducer housing is lower than the motor-side speed reducer housing.

### CROSS REFERENCE TO RELATED APPLICATIONS

This application is a continuation application of International Patent Application No. PCT/JP2023/018417 filed on May 17, 2023, which designated the U.S. and based on and claims the benefits of priority of Japanese Patent Application No. 2022-089069 filed on May 31, 2022.

### TECHNICAL FIELD

The present disclosure relates to a brake device for a vehicle.

### BACKGROUND ART

Conventionally, an electric brake device for the vehicle is known that converts a rotation from an electric motor, which is decelerated by a speed reducer, into linear motion and presses a pad against a disc of a wheel.

### SUMMARY

An object of the present disclosure is to provide a brake device for a vehicle that can ensure heat dissipation from components while suppressing heat transfer between components.

The present disclosure relates to a vehicle brake device capable of restricting rotation of a wheel by pressing a pad against a disc that is rotatable together with the wheel, and the vehicle brake device includes an electric motor, a speed reducer, a linear motion converter, an electronic circuit, a caliper-side speed reducer housing, and a motor-side speed reducer housing. The electric motor rotates when electricity is applied. The speed reducer reduces a rotation speed from the electric motor and outputs it. The linear motion converter is held by the caliper that holds the pad, and is capable of converting the rotation from the speed reducer into the linear motion and pressing the pad against the disk.

The electronic circuit controls the rotation of the electric motor. The caliper-side speed reducer housing is provided to accommodate a portion of the speed reducer and to be connected to the caliper. The motor-side speed reducer housing is provided to accommodate a portion of the speed reducer and to be connected to the caliper-side speed reducer housing. The electric motor is provided on one of the caliper-side speed reducer housing side and the opposite side to the caliper-side speed reducer housing with respect to the motor-side speed reducer housing. The electronic circuit is provided on the caliper-side speed reducer housing side or on the other side opposite to the caliper-side speed reducer housing with respect to the motor-side speed reducer housing.

The thermal conductivity of the caliper-side speed reducer housing is lower than the thermal conductivity of the motor-side speed reducer housing.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a cross-sectional view showing a brake device for a vehicle according to an embodiment; and

FIG. 2 is a perspective view showing a brake device for a vehicle according to an embodiment.

### DETAILED DESCRIPTION

In an assumable example, an electric brake device for the vehicle is known that converts a rotation from an electric motor, which is decelerated by a speed reducer, into linear motion and presses a pad against a disc of a wheel. For example, the brake device for the vehicle integrally includes an electric motor, a speed reducer, a linear motion converter, and an electronic circuit capable of controlling the rotation of the electric motor.

In the brake device for the vehicle, a heat dissipation surface of a power module of the electronic circuit is disposed opposite to a metal case, thereby improving the heat dissipation performance of the power module. In addition, a resin case or the like, which has a lower thermal conductivity than that of a metal case, is placed between the power module and the speed reducer, and between the electric motor and the linear motion converter, to suppress heat transfer between the power module and the reducer, and between the electric motor and the linear motion converter.

However, in the brake device for the vehicle, the speed reducer, the electric motor, and the linear motion converter are arranged in close proximity within the same housing, and no consideration is given to suppressing heat transfer between the speed reducer, the electric motor, and the linear motion converter. Therefore, there is a risk that frictional heat between the pad and the disk will be transmitted to the electric motor and the speed reducer via the linear motion converter.

An object of the present disclosure is to provide a brake device for a vehicle that can ensure heat dissipation from components while suppressing heat transfer between components.

The present disclosure relates to a vehicle brake device capable of restricting rotation of a wheel by pressing a pad against a disc that is rotatable together with the wheel, and the vehicle brake device includes an electric motor, a speed reducer, a linear motion converter, an electronic circuit, a caliper-side speed reducer housing, and a motor-side speed reducer housing. The electric motor rotates when electricity is applied. The speed reducer reduces a rotation speed from the electric motor and outputs it. The linear motion converter is held by the caliper that holds the pad, and is capable of converting the rotation from the speed reducer into the linear motion and pressing the pad against the disk.

The electronic circuit is capable of controlling the rotation of the electric motor. The caliper-side speed reducer housing is provided to accommodate a portion of the speed reducer and to be connected to the caliper. The motor-side speed reducer housing is provided to accommodate a portion of the speed reducer and to be connected to the caliper-side speed reducer housing. The electric motor is provided on one of the caliper-side speed reducer housing side and the opposite side to the caliper-side speed reducer housing with respect to the motor-side speed reducer housing. The electronic circuit is provided on the caliper-side speed reducer housing side or on the other side opposite to the caliper-side speed reducer housing with respect to the motor-side speed reducer housing.

The thermal conductivity of the caliper-side speed reducer housing is lower than the thermal conductivity of the motor-side speed reducer housing. Therefore, heat transfer between the caliper connected to the caliper-side speed reducer housing and the electric motor and electronic circuit provided on both sides of the motor-side speed reducer housing connected to the caliper-side speed reducer housing can be suppressed. This makes it possible to suppress the transmission of frictional heat between the pad and the disk to the speed reducer, the electric motor, and the electronic circuit. Therefore, the temperature rise of the speed reducer, the electric motor, and the electronic circuit during operation of the vehicle brake device can be suppressed.

In addition, the electric motor and the electronic circuit are provided on both sides of a motor-side speed reducer housing that has a higher thermal conductivity than that of the caliper-side speed reducer housing. This ensures heat dissipation from components such as the electric motor and heat-generating components of the electronic circuit.

Hereinafter, a brake device for a vehicle according to an embodiment will be described with reference to the drawings. It should be noted that in the embodiment, substantially the same components are denoted by the same reference numerals and descriptions thereof will be omitted.

### One Embodiment

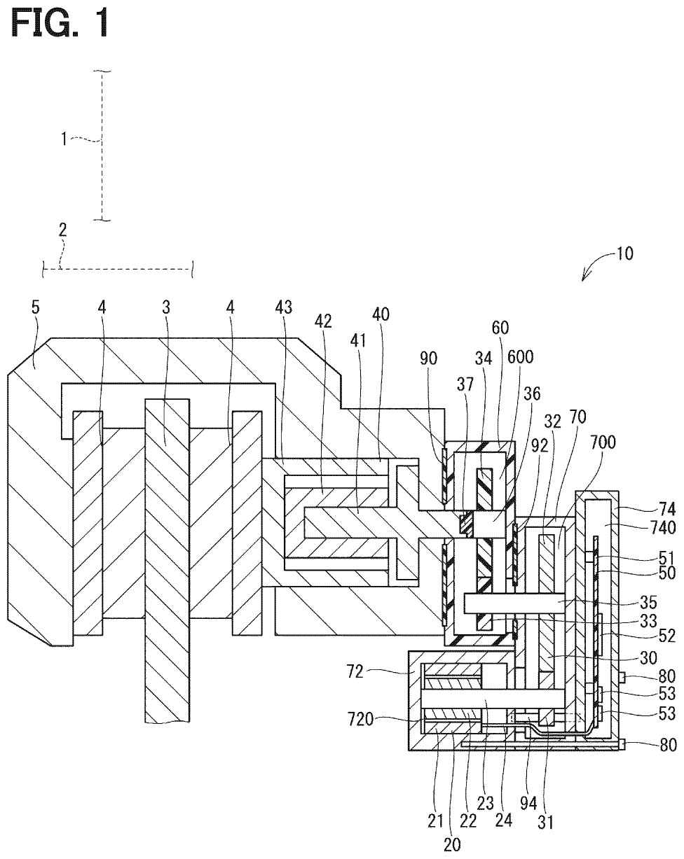

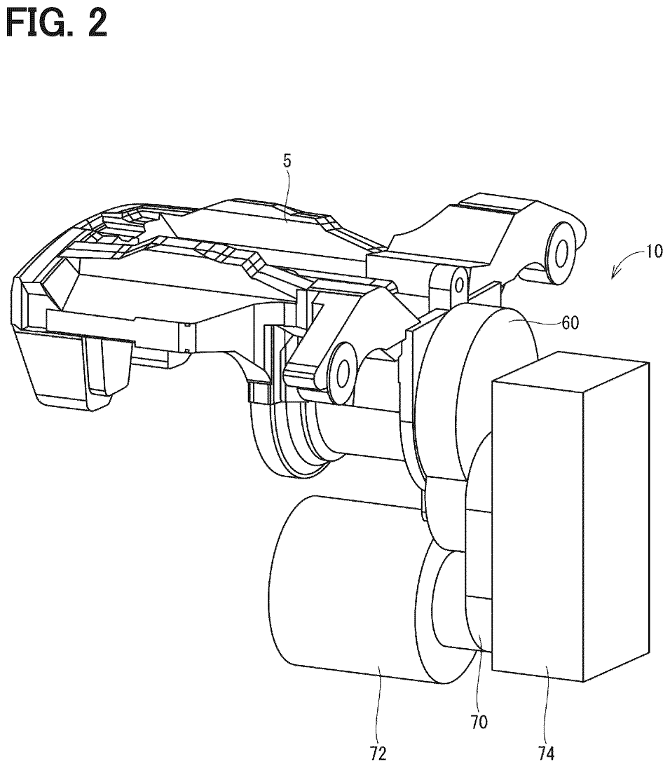

An embodiment of a brake device for a vehicle is shown in FIGS. 1 and 2. A vehicle brake device 10 is provided in, for example, a vehicle 1. The vehicle brake device 10 is capable of restricting the rotation of a wheel 2 by pressing a pad 4 against a disc 3 that is provided so as to be rotatable together with the wheel 2. The vehicle 1 can be maintained in a stopped state while it is stopped, and the vehicle 1 can be decelerated or stopped while it is moving.

The vehicle 1 is provided with a caliper 5. The caliper 5 is made of, for example, metal, and is fixed to the vehicle 1 in a manner that allows it to move in response to wear of the pad 4. The caliper 5 holds the two pads 4. The disk 3 is located between the two pads 4.

The vehicle brake device 10 includes an electric motor 20, a speed reducer 30, a linear motion converter 40, an electronic circuit 50, a caliper-side speed reducer housing 60, a motor-side speed reducer housing 70, a motor housing 72, an electronic circuit housing 74, a fastening member 80, a heat insulating member 90, a heat insulating member 92, a heat transfer member 94, etc. The electric motor 20 rotates when electricity is applied. The speed reducer 30 reduces a rotation speed from the electric motor 20 and outputs it. The linear motion converter 40 is held by the caliper 5 that holds the pad 4, and is capable of converting the rotation from the speed reducer 30 into the linear motion and pressing the pad 4 against the disk 3.

More specifically, the electric motor 20 is, for example, a three-phase brushless motor, and has a stator 21 and a rotor 22. The stator 21 is fixed to the motor housing 72, which will be described later. The rotor 22 is provided so as to be rotatable relative to the stator 21. A shaft 23 is provided at the center of the rotor 22. The shaft 23 rotates together with the rotor 22 to output torque.

The speed reducer 30 has a first pinion gear 31, a first wheel gear 32, a second pinion gear 33, a second wheel gear 34, a gear shaft 35, a gear shaft 36, a connecting member 37, etc. The first pinion gear 31 is made of, for example, metal. The first wheel gear 32 is made of, for example, metal, has an outer diameter set to be larger than that of the first pinion gear 31, and meshes with the first pinion gear 31.

The second pinion gear 33 is made of, for example, resin, has an outer diameter smaller than that of the first wheel gear 32, and is provided coaxially with the first wheel gear 32 so as to be rotatable together with the first wheel gear 32. The second wheel gear 34 is made of, for example, resin, has an outer diameter set to be larger than that of the second pinion gear 33, and meshes with the second pinion gear 33.

The gear shaft 35 is made of, for example, metal, and is rotatably supported by the motor-side speed reducer housing 70, which will be described later. The gear shaft 36 is made of, for example, metal, and is rotatably supported by the caliper-side speed reducer housing 60, which will be described later. The connecting member 37 is made, for example, of resin, and connects a rotating member 41 of the linear motion converter 40 described later to the gear shaft 36 so as to be able to transmit rotation between the gear shaft 36 and the rotating member 41.

The first pinion gear 31 is provided on an opposite side of the shaft 23 to the rotor 22 so as to rotate together with the shaft 23. The first wheel gear 32 is arranged coaxially with the gear shaft 35 so as to be rotatable together with the gear shaft 35 while meshing with the first pinion gear 31. The second pinion gear 33 is arranged coaxially with the gear shaft 35 so as to be rotatable together with the first wheel gear 32 and the gear shaft 35. The second wheel gear 34 is arranged coaxially with the gear shaft 36 so as to be rotatable together with the gear shaft 36 while meshing with the second pinion gear 33.

With the above configuration, when the rotor 22 of the electric motor 20 rotates and the shaft 23 rotates, the first pinion gear 31 rotates, the first wheel gear 32 and the second pinion gear 33 meshing with the first pinion gear 31 rotate, and the second wheel gear 34 meshing with the second pinion gear 33 rotates. As a result, the rotation from the electric motor 20 is decelerated and output from the gear shaft 36.

The linear motion converter 40 has a rotating member 41, a linear motion member 42, and a piston 43. The rotating member 41 is made of, for example, metal and has a generally cylindrical shape, and is rotatably supported by the caliper 5. One end of the rotating member 41 is connected to the gear shaft 36 via the connecting member 37.

The linear motion member 42 is made of, for example, a metal, and is provided on the other end side of the rotating member 41. The linear motion member 42 is provided so as to be movable relative to the caliper 5 in the axial direction when the rotating member 41 rotates. In this manner, the rotating member 41 can convert the input rotation into linear motion.

The piston 43 is formed, for example, in a cylindrical shape with a bottom. The piston 43 is provided so that an inner wall of a bottom part can abut against the linear motion member 42. The piston 43 is provided so as to be movable relative to the caliper 5 in the axial direction.

The vehicle brake device 10 is provided on the vehicle 1 so that a side of the piston 43 opposite to the linear motion member 42 can abut against the pad 4. When the electric motor 20 rotates in a forward direction due to energization, the rotation is reduced in speed and output from the gear shaft 36 of the speed reducer 30. As a result, the rotating member 41 rotates relative to the caliper 5. As a result, the linear motion member 42 moves toward the pad 4, and the piston 43 is pressed against the pad 4. As a result, the pad 4 is pressed against the disk 3, and the rotation of the wheel 2 is restricted.

On the other hand, when the electric motor 20 rotates in a reverse direction, the rotation is reduced and output from the gear shaft 36 of the speed reducer 30. As a result, the rotating member 41 rotates relative to the caliper 5 in the opposite direction to the above direction. As a result, the linear motion member 42 moves in the opposite direction to the pad 4. As a result, the pressing of the piston 43 against the pad 4, as well as the pressing of the pad 4 against the disc 3, is released, allowing the rotation of wheel 2.

The electronic circuit 50 is capable of controlling the rotation of the electric motor 20. The caliper-side speed reducer housing 60 is provided to accommodate a portion of the speed reducer 30 and to be connected to the caliper 5. The motor-side speed reducer housing 70 is provided to accommodate a portion of the speed reducer 30 and to be connected to the caliper-side speed reducer housing 60. The electric motor 20 is provided on the caliper-side speed reducer housing 60 side with respect to the motor-side speed reducer housing 70. The electronic circuit 50 is provided on the opposite side of the motor-side speed reducer housing 70 to the caliper-side speed reducer housing 60.

More specifically, the electronic circuit 50 includes a substrate 51, a microcomputer 52, a switching element 53, and the like. The substrate 51 is made of, for example, resin and has a plate shape. The microcomputer 52 is mounted on one surface of the substrate 51, for example. A plurality of switching elements 53 are mounted on one surface of the substrate 51, for example. The microcomputer 52 is a small computer having a CPU, memory, input/output portions, etc., and is capable of controlling the supply of electricity to the electric motor 20 by controlling the operation of the switching elements 53 based on signals from various sensors attached to the vehicle 1.

The caliper-side speed reducer housing 60 is made of, for example, resin and has a flat box shape. The caliper-side speed reducer housing 60 has a space 600 inside. The caliper-side speed reducer housing 60 accommodates within a space 600 the second pinion gear 33, the second wheel gear 34, the gear shaft 36, and the connecting member 37, which are among the components that constitute the speed reducer 30. A part of the gear shaft 35 is located in the space 600.

The caliper-side speed reducer housing 60 is provided so that one end surface thereof is connected to the end surface of the caliper 5 opposite to the piston 43. Here, “connect” refers not only to a state in which two components are connected so that they are in direct contact with each other, but also to a state in which they are indirectly connected with another component sandwiched between them (the same applies below).

The motor-side speed reducer housing 70 is made of, for example, metal and has a flat box shape. The motor-side speed reducer housing 70 defines a space 700 therein. The motor-side speed reducer housing 70 accommodates, in the space 700, the first pinion gear 31 and the first wheel gear 32, which are among the components that constitute the speed reducer 30. A part of the shaft 23 and a part of the gear shaft 35 are located in the space 700.

The motor-side speed reducer housing 70 is provided such that a portion of one end surface thereof is connected to the end surface of the caliper-side speed reducer housing 60 opposite to the caliper 5.

The electric motor 20 is provided on the caliper-side speed reducer housing 60 side with respect to the end face of the motor-side speed reducer housing 70 that is connected to the caliper-side speed reducer housing 60. The electronic circuit 50 is provided on the opposite side to the caliper-side speed reducer housing 60 with respect to the end face of the motor-side speed reducer housing 70 opposite the end face connected to the caliper-side speed reducer housing 60.

The thermal conductivity of the caliper-side speed reducer housing is lower than the thermal conductivity of the motor-side speed reducer housing.

More specifically, the caliper-side speed reducer housing 60 is made of resin and has a lower thermal conductivity than the motor-side speed reducer housing 70 which is made of metal.

The motor housing 72 is provided to accommodate the electric motor 20 and to be connected to the motor-side speed reducer housing 70. The electronic circuit housing 74 is provided to accommodate the electronic circuit 50 and to be connected to the motor-side speed reducer housing 70. The thermal conductivity of the motor housing 72 and the electronic circuit housing 74 is higher than the thermal conductivity of the caliper-side speed reducer housing 60.

More specifically, the motor housing 72 is made of, for example, metal and has a box-like shape. The motor housing 72 defines a space 720 therein. The motor housing 72 accommodates the stator 21 and the rotor 22 of the electric motor 20 in the space 720. The stator 21 is fixed to the inner wall of the motor housing 72. A part of the shaft 23 is located in the space 720.

The motor housing 72 is provided so that one end surface thereof is connected to the end surface of the motor-side speed reducer housing 70 on the caliper-side speed reducer housing 60 side. Here, the motor housing 72 and the motor-side speed reducer housing 70 are connected so as to be in direct contact with each other.

The electronic circuit housing 74 is made of, for example, metal and has a flat box shape. The electronic circuit housing 74 defines a space 740 therein. The electronic circuit housing 74 accommodates the substrate 51, the microcomputer 52, and the switching elements 53 of the electronic circuit 50 in the space 740.

The electronic circuit housing 74 is provided so that one end surface thereof is connected to the end surface of the motor-side speed reducer housing 70 opposite to the caliper-side speed reducer housing 60. Here, the electronic circuit housing 74 and the motor-side speed reducer housing 70 are connected so as to be in direct contact with each other.

The motor housing 72 and the electronic circuit housing 74 are made of metal and have a higher thermal conductivity than the caliper-side speed reducer housing 60, which is made of resin.

A coil (not shown) wound around the stator 21 of the electric motor 20 and the switching elements 53 of the electronic circuit 50 are electrically connected by a conductor 24. The conductor 24 is formed in a linear shape made of, for example, a metal, and extends from the space 600 through the space 700 to the space 740.

One or more fastening members 80 are provided, and fasten the motor housing 72 and the electronic circuit housing 74 together via the motor-side speed reducer housing 70.

More specifically, the fastening member 80 is made of, for example, metal and is formed into a long screw shape. The fastening member 80 is screwed into the motor housing 72 so as to pass through the electronic circuit housing 74 and the motor-side speed reducer housing 70 with the motor-side speed reducer housing 70 sandwiched between the motor housing 72 and the electronic circuit housing 74. In this manner, the motor housing 72 and the electronic circuit housing 74 are fastened together via the motor-side speed reducer housing 70 by one or more fastening members 80. The thermal conductivity of the fastening member 80 is higher than the thermal conductivity of the caliper-side speed reducer housing 60.

The thermal conductivity of some of the members constituting the speed reducer 30 is lower than the thermal conductivity of the motor-side speed reducer housing 70.

More specifically, among the components that constitutes the speed reducer 30, the second pinion gear 33, the second wheel gear 34, and the connecting member 37 are formed from resin, and have a lower thermal conductivity than the thermal conductivity of the motor-side speed reducer housing 70, which is formed from metal.

The speed reducer 30 has a reduction mechanism with two or more stages. The caliper-side speed reducer housing 60 houses one or more stages of reduction mechanisms counted from the caliper 5 side out of the reduction mechanisms. The motor-side speed reducer housing 70 houses one or more stages of the reduction mechanisms, counted from the electric motor 20 side.

More specifically, the speed reducer 30 has a two-stage reduction mechanism consisting of a reduction mechanism consisting of a first pinion gear 31 and a first wheel gear 32, and a reduction mechanism consisting of a second pinion gear 33 and a second wheel gear 34. The caliper-side speed reducer housing 60 accommodates the second pinion gear 33 and the second wheel gear 34 which are the first-stage reduction mechanism counted from the caliper 5 side of the two reduction mechanisms. The motor-side speed reducer housing 70 accommodates the first pinion gear 31 and the first wheel gear 32 which are the first-stage reduction mechanism counted from the electric motor 20 side of the two reduction mechanisms.

The insulating members 90 and 92 are made of a material having a lower thermal conductivity than that of the caliper-side speed reducer housing 60, and are provided between the caliper 5 and the caliper-side speed reducer housing 60, or between the caliper-side speed reducer housing 60 and the motor-side speed reducer housing 70, so that the thermal resistance between the caliper 5 and the electric motor 20 is greater than the thermal resistance between the electric motor 20 and the electronic circuit 50.

More specifically, the heat insulating members 90 and 92 are made of, for example, resin and are formed into a plate shape. The heat insulating members 90 and 92 have a lower thermal conductivity than the thermal conductivity of the caliper-side speed reducer housing 60 which is made of resin. The heat insulating member 90 is provided between the end face of the caliper 5 on the caliper-side speed reducer housing 60 side and the end face of the caliper-side speed reducer housing 60 on the caliper 5 side. As a result, the thermal resistance between the caliper 5 and the electric motor 20 becomes greater than the thermal resistance between the electric motor 20 and the electronic circuit 50.

The heat transfer member 94 is made of a material having a higher thermal conductivity than the caliper-side speed reducer housing 60, and is provided between the electric motor 20 and the electronic circuit 50 so that the thermal resistance between the caliper 5 and the electric motor 20 is greater than the thermal resistance between the electric motor 20 and the electronic circuit 50.

More specifically, the heat transfer member 94 is made of, for example, metal and is formed into a rod shape. The heat transfer member 94 is made of metal and has a higher thermal conductivity than the caliper-side speed reducer housing 60, which is also made of metal. The heat transfer member 94 is provided between the electric motor 20 and the electronic circuit 50 so as to connect the motor housing 72 and the electronic circuit housing 74. As a result, the thermal resistance between the caliper 5 and the electric motor 20 becomes greater than the thermal resistance between the electric motor 20 and the electronic circuit 50.

As described above, in the present embodiment, the linear motion converter 40 is held by the caliper 5 that holds the pad 4, and is capable of converting the rotation from the speed reducer 30 into the linear motion and pressing the pad 4 against the disk 3. The electronic circuit 50 is capable of controlling the rotation of the electric motor 20. The caliper-side speed reducer housing 60 is provided to accommodate a portion of the speed reducer 30 and to be connected to the caliper 5. The motor-side speed reducer housing 70 is provided to accommodate a portion of the speed reducer 30 and to be connected to the caliper-side speed reducer housing 60. The electric motor 20 is provided on the caliper-side speed reducer housing 60 side with respect to the motor-side speed reducer housing 70. The electronic circuit 50 is provided on the opposite side of the motor-side speed reducer housing 70 to the caliper-side speed reducer housing 60. The thermal conductivity of the caliper-side speed reducer housing is lower than the thermal conductivity of the motor-side speed reducer housing.

Therefore, heat transfer between the caliper 5 connected to the caliper-side speed reducer housing 60 and the electric motor 20 and electronic circuit 50 provided on both sides of the motor-side speed reducer housing 70 connected to the caliper-side speed reducer housing 60 can be suppressed. This makes it possible to suppress the transmission of frictional heat between the pad 4 and the disk 3 to the speed reducer 30, the electric motor 20, and the electronic circuit 50. Therefore, the temperature rise of the speed reducer 30, the electric motor 20, and the electronic circuit 50 during operation of the vehicle brake device 10 can be suppressed.

In addition, the electric motor 20 and the electronic circuit 50 are provided on both sides of a motor-side speed reducer housing 70 that has a higher thermal conductivity than that of the caliper-side speed reducer housing 60. Therefore, heat dissipation properties of the electric motor 20 and the switching elements 53, which are heat-generating components of the electronic circuit 50, can be ensured.

The motor housing 72 is provided to accommodate the electric motor 20 and to be connected to the motor-side speed reducer housing 70. The electronic circuit housing 74 is provided to accommodate the electronic circuit 50 and to be connected to the motor-side speed reducer housing 70. The thermal conductivity of the motor housing 72 and the electronic circuit housing 74 is higher than the thermal conductivity of the caliper-side speed reducer housing 60.

Therefore, heat dissipation from the electric motor 20 and the electronic circuit 50 can be promoted.

One or more fastening members 80 are provided, and fasten the motor housing 72 and the electronic circuit housing 74 together via the motor-side speed reducer housing 70.

Therefore, the Heat transfer between the motor housing 72 and the electronic circuit housing 74 can be promoted, and when there is a temperature difference between the electric motor 20 and the electronic circuit 50, the temperature rise can be suppressed by transferring heat to the lower temperature side.

In the present embodiment, the thermal conductivity of the fastening member 80 is higher than the thermal conductivity of the caliper-side speed reducer housing 60. Therefore, the fastening member 80 can effectively promote heat transfer between the motor housing 72 and the electronic circuit housing 74.

The thermal conductivity of some of the members constituting the speed reducer 30 is lower than the thermal conductivity of the motor-side speed reducer housing 70.

Therefore, the frictional heat between the pad 4 and the disk 3 can be effectively prevented from being transmitted to the electric motor 20 and the electronic circuit 50 via the speed reducer 30.

The speed reducer 30 has a reduction mechanism with two or more stages. The caliper-side speed reducer housing 60 houses one or more stages of reduction mechanisms counted from the caliper 5 side out of the reduction mechanisms. The motor-side speed reducer housing 70 houses one or more stages of the reduction mechanisms, counted from the electric motor 20 side.

In this way, the motor-side speed reducer housing 70 is arranged between the caliper 5 and the caliper-side speed reducer housing 60, and by arranging the motor-side speed reducer housing 70 in a position where the influence of heat transfer from the caliper 5 side is minimal, heat transfer between the caliper 5, the electric motor 20, and electronic circuit 50 can be effectively suppressed.

The insulating members 90 and 92 are made of a material having a lower thermal conductivity than that of the caliper-side speed reducer housing 60, and are provided between the caliper 5 and the caliper-side speed reducer housing 60, or between the caliper-side speed reducer housing 60 and the motor-side speed reducer housing 70, so that the thermal resistance between the caliper 5 and the electric motor 20 is greater than the thermal resistance between the electric motor 20 and the electronic circuit 50.

The heat transfer member 94 is made of a material having a higher thermal conductivity than the caliper-side speed reducer housing 60, and is provided between the electric motor 20 and the electronic circuit 50 so that the thermal resistance between the caliper 5 and the electric motor 20 is greater than the thermal resistance between the electric motor 20 and the electronic circuit 50.

Therefore, when there is a temperature difference between the electric motor 20 and the electronic circuit 50, the temperature rise can be suppressed by transferring heat to the lower temperature side.

### (Other Embodiments)

In the above-described embodiment, an example has been shown in which the electric motor is provided on the caliper-side speed reducer housing side relative to the motor-side speed reducer housing, and the electronic circuit is provided on the opposite side of the motor-side speed reducer housing to the caliper-side speed reducer housing. In contrast to this configuration, in other embodiments, the electric motor may be provided on the opposite side of the motor-side speed reducer housing from the caliper-side speed reducer housing, and the electronic circuit may be provided on the caliper-side speed reducer housing side relative to the motor-side speed reducer housing.

In other embodiments, as long as the thermal conductivity of the caliper-side speed reducer housing is lower than the thermal conductivity of the motor-side speed reducer housing, the caliper-side speed reducer housing and the motor-side speed reducer housing may be formed from any material, such as metal or resin.

In another embodiment, the thermal conductivity of the motor housing and the electronic circuit housing may be equal to or lower than the thermal conductivity of the caliper-side speed reducer housing.

In other embodiments, only one fastening member may be provided. Additionally, in other embodiments, fastening members may not be provided.

In another embodiment, all of the members constituting the speed reducer may have a thermal conductivity equal to or greater than the thermal conductivity of the motor-side speed reducer housing.

In addition, in other embodiments, the speed reducer may have a reduction mechanism with three or more stages. In this case, the caliper-side speed reducer housing accommodates at least one reduction mechanism.

In addition, in other embodiments, the heat insulating member may be provided only either between the caliper and the caliper-side speed reducer housing or between the caliper-side speed reducer housing and the motor-side speed reducer housing. In other embodiments, the heat insulating member may not be provided.

In other embodiments, a plurality of heat transfer members may be provided. In addition, in other embodiments, the heat transfer member 94 may be formed integrally with the motor-side speed reducer housing 70. In other embodiments, the heat transfer member may not be provided.

In other embodiments, the electric motor may be a motor other than a three-phase brushless motor.

In addition, in other embodiments, the linear motion converter may have any configuration as long as it can convert the rotation from the speed reducer into linear motion and press the pad against the disk.

The vehicle brake device of the present disclosure may be applied to all of a plurality of wheels of a vehicle, or may be applied to only some of the wheels.

The vehicle brake device of the present disclosure can be used as a parking brake, and can also be used as a braking brake for slowing down or stopping a moving vehicle.

Thus, the present disclosure is not limited to the above embodiments but can be implemented in various forms without departing from the scope thereof.

The present disclosure has been described based on the embodiments. However, the present disclosure is not limited to the embodiments and structures. The present disclosure also encompasses various modifications and variations within the scope of equivalents. Furthermore, various combination and formation, and other combination and formation including one, more than one or less than one element may be made in the present disclosure.

What is claimed is:

1. A brake device for a vehicle for restricting a rotation of a wheel by pressing a pad against a disk that is rotatable together with the wheel, the brake device for the vehicle, comprising:
an electric motor that rotates when energized;
a speed reducer that reduces a rotation speed from the electric motor and outputs the reduced speed;
a linear motion converter that is held by a caliper that holds the pad, converts the rotation from the speed reducer into linear motion, and presses the pad against the disk;
an electronic circuit that controls the rotation of the electric motor;
a caliper-side speed reducer housing that houses a part of the speed reducer and is provided to be connected to the caliper; and
a motor-side speed reducer housing that houses a part of the speed reducer and is provided to be connected to the caliper-side speed reducer housing; wherein
the electric motor is provided on one of the caliper-side speed reducer housing side and the opposite side to the caliper-side speed reducer housing with respect to the motor-side speed reducer housing,
the electronic circuit is provided on the caliper-side speed reducer housing side or on the other side opposite to the caliper-side speed reducer housing with respect to the motor-side speed reducer housing, and
the caliper-side speed reducer housing has a lower thermal conductivity than the thermal conductivity of the motor-side speed reducer housing.

2. The brake device for the vehicle according to claim 1, further comprising;
a motor housing that houses the electric motor and is provided to be connected to the motor-side speed reducer housing, and
an electronic circuit housing that houses the electronic circuit and is provided to be connected to the motor-side speed reducer housing, wherein
the motor housing and the electronic circuit housing have a higher thermal conductivity than the thermal conductivity of the caliper-side speed reducer housing.

3. The brake device for the vehicle according to claim 2, further comprising;
one or more fastening members that integrally fasten the motor housing and the electronic circuit housing via the motor-side speed reducer housing.

4. The brake device for the vehicle according to claim 1, wherein
the thermal conductivity of a portion of members constituting the speed reducer is lower than the thermal conductivity of the motor-side speed reducer housing.

5. The brake device for the vehicle according to claim 1, wherein
the speed reducer has a reduction mechanism with two or more stages,
the caliper-side speed reducer housing accommodates one or more stages of the reduction mechanism, counted from the caliper side, of the reduction mechanism, and
the motor-side speed reducer housing accommodates one or more stages of the reduction mechanism, counted from the electric motor side, of the reduction mechanism.

6. The brake device for the vehicle according to claim 1, further comprising;
an insulating member that is made of a material having a lower thermal conductivity than that of the caliper-side speed reducer housing, and is provided between the caliper and the caliper-side speed reducer housing, or between the caliper-side speed reducer housing and the motor-side speed reducer housing, so that a thermal resistance between the caliper and the electric motor is greater than a thermal resistance between the electric motor and the electronic circuit.

7. The brake device for the vehicle according to claim 1, further comprising;
a heat transfer member that is made of a material having a higher thermal conductivity than the caliper-side speed reducer housing, and is provided between the electric motor and the electronic circuit so that a thermal resistance between the caliper and the electric motor is greater than a thermal resistance between the electric motor and the electronic circuit.
